(19) United States
(12) Patent Application Publication
(10) Pub. No.: US 2025/0089028 A1
(43) Pub. Date: Mar. 13, 2025

(54) INDICATION OF A PRESENCE OF A FIRST FRAME VIA A FIELD IN A SECOND FRAME

(71) Applicant: QUALCOMM Incorporated, San Diego, CA (US)

(72) Inventors: Abhishek Pramod PATIL, San Diego, CA (US); Alfred ASTERJADHI, San Diego, CA (US); George CHERIAN, San Diego, CA (US); Sai Yiu Duncan HO, San Diego, CA (US); Gaurang NAIK, San Diego, CA (US); Yanjun SUN, San Diego, CA (US); Abdel Karim AJAMI, San Diego, CA (US)

(21) Appl. No.: 18/824,803

(22) Filed: Sep. 4, 2024

Related U.S. Application Data
(60) Provisional application No. 63/582,512, filed on Sep. 13, 2023.
(60) Provisional application No. 63/618,586, filed on Jan. 8, 2024.

(51) Int. Cl. H04W 72/0446; H04W 74/0808

(52) U.S. Cl. CPC H04W 72/0446; H04W 74/0808

(57) ABSTRACT

This disclosure provides a method for wireless communication performable at an access point (AP). The AP transmits a first frame to a non-AP wireless station (STA). A first field of the first frame indicates transmission information associated with one or more second frames. A second field of the first frame contains a first set of parameters associated with the AP. The AP further transmits a second frame to the non-AP wireless STA. The second frame may include at least one field containing a second set of parameters associated with the AP. The first set of parameters are different from the second set of parameters.

### CROSS-REFERENCE TO RELATED APPLICATIONS

This application claims benefit of and priority to U.S. Provisional Patent Application No. 63/582,512, filed Sep. 13, 2023 and U.S. Provisional Patent Application No. 63/618,586, filed Jan. 8, 2024, which are incorporated herein by reference in their entireties.

### TECHNICAL FIELD

This disclosure relates generally to wireless communication, and more specifically, to managing content and transmission of beacon and other frames.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

### SUMMARY

The systems, methods and devices of this disclosure each have several innovative aspects, no single one of which is solely responsible for the desirable attributes disclosed herein.

One aspect provides a method for wireless communication performable at a first wireless node. The method includes outputting a first frame comprising one or more first fields, wherein at least one of the one or more first fields indicates at least one of: a presence of one or more second frames, a presence of at least one of one or more second fields or second elements in at least one of the one or more second frames, or one or more attributes corresponding to the at least one of the one or more second frames; and outputting the one or more second frames.

Another aspect provides a method for wireless communication performable at a first wireless node. The method includes obtaining a first frame comprising one or more first fields, wherein at least one of the one or more first fields indicates at least one of: a presence of one or more second frames, a presence of at least one of one or more second fields or second elements in at least one of the one or more second frames, or one or more attributes corresponding to the at least one of the one or more second frames; and obtaining the one or more second frames.

Another aspect provides a method for wireless communication performable at a first wireless node. The method includes outputting a first frame comprising a plurality of fields. A first field of the first frame indicates transmission information associated with one or more second frames and a second field of the first frame contains a first set of parameters associated with the first wireless node. The method further includes outputting the one or more second frames. One of the one or more second frames comprises at least one field containing a second set of parameters associated with the first wireless node. The first set of parameters are different from the second set of parameters.

Another aspect provides a method for wireless communication performable at a first wireless node. The method includes obtaining a first frame comprising a plurality of fields. A first field of the first frame indicates transmission information associated with one or more second frames and a second field of the first frame contains a first set of parameters associated with a second apparatus. The method further includes obtaining the one or more second frames. One of the one or more second frames comprises at least one field containing a second set of parameters associated with the second apparatus. The first set of parameters are different from the second set of parameters. The method further includes processing the first frame and the one or more second frames.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows a hierarchical format of an example physical layer PDU (PPDU) usable for communications between a wireless AP and one or more wireless STAs.

FIG. 4 shows a pictorial diagram of another example wireless communication network.

FIG. 5 shows a block diagram of an example multi-link device (MLD) deployment.

FIG. 6 shows a block diagram of example links between STAs of different MLDs.

FIG. 7 shows a block diagram of example multi-link traffic indication control field format.

FIG. 8 shows a block diagram of example link recommendation frame action field format.

FIG. 9 shows a flowchart illustrating example process performable by a wireless device or wireless node.

FIG. 10 shows another flowchart illustrating example process performable by a wireless device or wireless node.

FIG. 11 shows a flowchart illustrating example process performable by a first wireless node.

FIG. 12 shows another flowchart illustrating example process performable by a first wireless node.

FIG. 13 shows a block diagram of an example wireless communication device or node.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IOT) network.

Various aspects relate generally to wireless communication. Some aspects more specifically relate to managing content and transmission of beacon and other frames.

### Example Wireless Communication Network

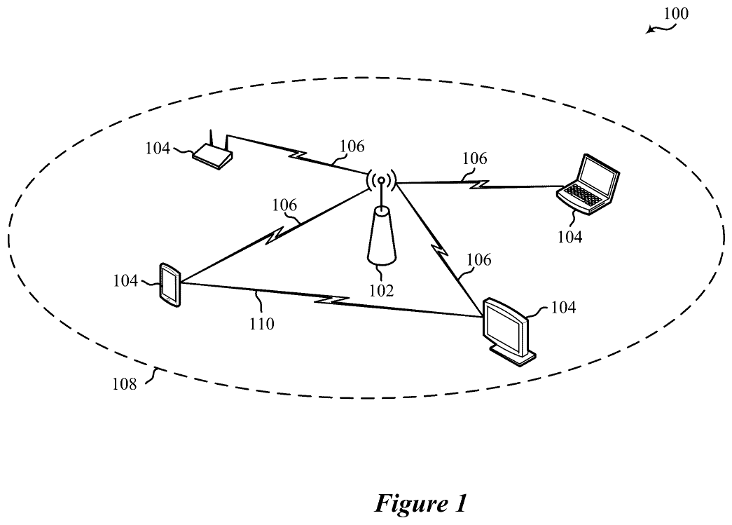

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core.

The wireless communication network 100 may include numerous wireless communication devices including at least one wireless access point (AP) 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the WLAN 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

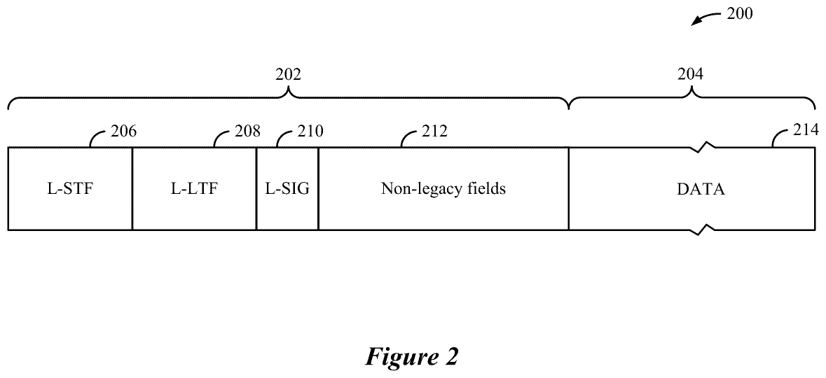

FIG. 2 shows an example protocol data unit (PDU) 200 usable for wireless communication between a wireless AP 102 and one or more wireless STAs 104. For example, the PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device to perform coarse timing and frequency tracking and automatic gain control (AGC). The L-LTF 208 generally enables a receiving device to perform fine timing and frequency tracking and also to perform an initial estimate of the wireless channel. The L-SIG 210 generally enables a receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

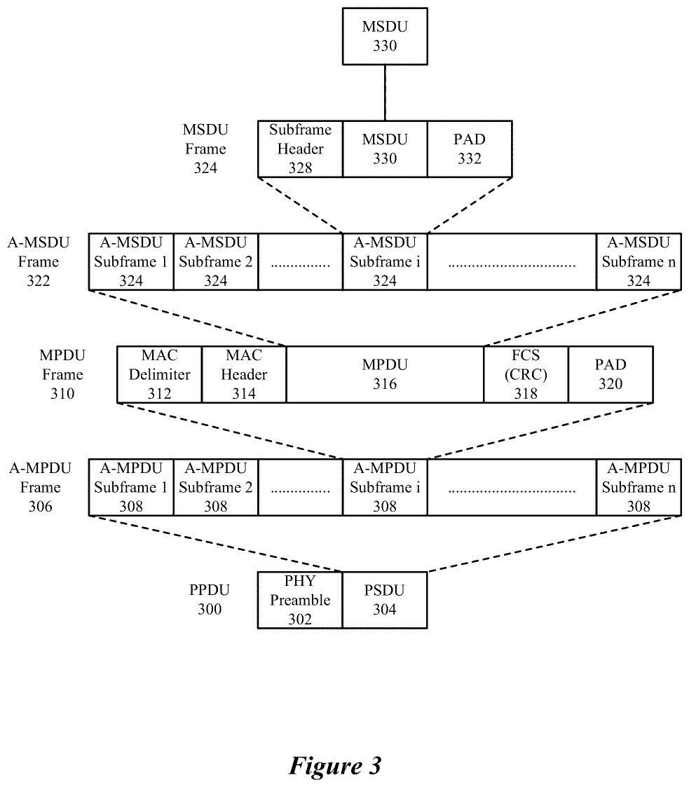

FIG. 3 shows a hierarchical format of an example PPDU usable for communications between a wireless AP 102 and one or more wireless STAs 104. As described, each PPDU 300 includes a PHY preamble 302 and a PSDU 304. Each PSDU 304 may represent (or “carry”) one or more MAC protocol data units (MPDUs) 316. For example, each PSDU 304 may carry an aggregated MPDU (A-MPDU) 306 that includes an aggregation of multiple A-MPDU subframes 308. Each A-MPDU subframe 306 may include an MPDU frame 310 that includes a MAC delimiter 312 and a MAC header 314 prior to the accompanying MPDU 316, which includes the data portion (“payload” or “frame body”) of the MPDU frame 310. Each MPDU frame 310 also may include a frame check sequence (FCS) field 318 for error detection (for example, the FCS field may include a cyclic redundancy check (CRC)) and padding bits 320. The MPDU 316 may carry one or more MAC service data units (MSDUs) 316. For example, the MPDU 316 may carry an aggregated MSDU (A-MSDU) 322 including multiple A-MSDU subframes 324. Each A-MSDU subframe 324 contains a corresponding MSDU 330 preceded by a subframe header 328 and in some cases followed by padding bits 332.

Referring back to the MPDU frame 310, the MAC delimiter 312 may serve as a marker of the start of the associated MPDU 316 and indicate the length of the associated MPDU 316. The MAC header 314 may include multiple fields containing information that defines or indicates characteristics or attributes of data encapsulated within the frame body 316. The MAC header 314 includes a duration field indicating a duration extending from the end of the PPDU until at least the end of an acknowledgment (ACK) or Block ACK (BA) of the PPDU that is to be transmitted by the receiving wireless communication device. The use of the duration field serves to reserve the wireless medium for the indicated duration, and enables the receiving device to establish its network allocation vector (NAV). The MAC header 314 also includes one or more fields indicating addresses for the data encapsulated within the frame body 316. For example, the MAC header 314 may include a combination of a source address, a transmitter address, a receiver address or a destination address. The MAC header 314 may further include a frame control field containing control information. The frame control field may specify a frame type, for example, a data frame, a control frame, or a management frame.

Some APs and STAs may implement techniques for spatial reuse that involve participation in a coordinated communication scheme. According to such techniques, an AP may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP, The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some other examples of OFDMA techniques, each portion of the plurality of portions of the TXOP includes a set of frequency resources that do not overlap with any frequency resources of any other portion of the plurality of portions. In such implementations, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units (RUs) associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or EDCA techniques. Additionally, by enabling a group of APs associated with different BSSs to participate in a coordinated AP transmission session, during which the group of APs may share at least a portion of a single TXOP obtained by any one of the participating APs, such techniques may increase throughput across the BSSs associated with the participating APs and may also achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, an RX power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may then be allocated resources during the TXOP as described above.

Retransmission protocols, such as hybrid automatic repeat request (HARQ), also may offer performance gains. A HARQ protocol may support various HARQ signaling between transmitting and receiving wireless communication devices as well as signaling between the PHY and MAC layers to improve the retransmission operations in a WLAN. HARQ uses a combination of error detection and error correction. For example, a HARQ transmission may include error checking bits that are added to data to be transmitted using an error-detecting (ED) code, such as a cyclic redundancy check (CRC). The error checking bits may be used by the receiving device to determine if it has properly decoded the received HARQ transmission. In some examples, the original data (information bits) to be transmitted may be encoded with a forward error correction (FEC) code, such as using a low-density parity check (LDPC) coding scheme that systematically encodes the information bits to produce parity bits. The transmitting device may transmit both the original information bits as well as the parity bits in the HARQ transmission to the receiving device. The receiving device may be able to use the parity bits to correct errors in the information bits, thus avoiding a retransmission.

Implementing a HARQ protocol in a WLAN may improve reliability of data communicated from a transmitting device to a receiving device. The HARQ protocol may support the establishment of a HARQ session between the two devices. Once a HARQ session is established, If a receiving device cannot properly decode (and cannot correct the errors) a first HARQ transmission received from the transmitting device, the receiving device may transmit a HARQ feedback message to the transmitting device (for example, a negative acknowledgement (NACK)) that indicates at least part of the first HARQ transmission was not properly decoded. Such a HARQ feedback message may be different than the traditional Block ACK feedback message type associated with conventional ARQ. In response to receiving the HARQ feedback message, the transmitting device may transmit a second HARQ transmission to the receiving device to communicate at least part of further assist the receiving device in decoding the first HARQ transmission. For example, the transmitting device may include some or all of the original information bits, some or all of the original parity bits, as well as other, different parity bits in the second HARQ transmission. The combined HARQ transmissions may be processed for decoding and error correction such that the complete signal associated with the HARQ transmissions can be obtained.

In some examples, the receiving device may be enabled to control whether to continue the HARQ process or revert to a non-HARQ retransmission scheme (such as an ARQ protocol). Such switching may reduce feedback overhead and increase the flexibility for retransmissions by allowing devices to dynamically switch between ARQ and HARQ protocols during frame exchanges. Some implementations also may allow multiplexing of communications that employ ARQ with those that employ HARQ.

Some wireless communication devices (including both APs and STAs) are capable of multi-link operation (MLO). In some examples, MLO supports establishing multiple different communication links (such as a first link on the 2.4 GHz band, a second link on the 5 GHz band, and the third link on the 6 GHz band) between the STA and the AP. Each communication link may support one or more sets of channels or logical entities. In some cases, each communication link associated with a given wireless communication device may be associated with a respective radio of the wireless communication device, which may include one or more transmit/receive (Tx/Rx) chains, include or be coupled with one or more physical antennas, or include signal processing components, among other components. An MLO-capable device may be referred to as a multi-link device (MLD). For example, an AP MLD may include multiple APs each configured to communicate on a respective communication link with a respective one of multiple STAs of a non-AP MLD (also referred to as a “STA MLD”). The STA MLD may communicate with the AP MLD over one or more of the multiple communication links at a given time.

One type of MLO is multi-link aggregation (MLA), where traffic associated with a single STA is simultaneously transmitted across multiple communication links in parallel to maximize the utilization of available resources to achieve higher throughput. That is, during at least some duration of time, transmissions or portions of transmissions may occur over two or more links in parallel at the same time. In some examples, the parallel wireless communication links may support synchronized transmissions. In some other examples, or during some other durations of time, transmissions over the links may be parallel, but not be synchronized or concurrent. In some examples or durations of time, two or more of the links may be used for communications between the wireless communication devices in the same direction (such as all uplink or all downlink). In some other examples or durations of time, two or more of the links may be used for communications in different directions. For example, one or more links may support uplink communications and one or more links may support downlink communications. In such examples, at least one of the wireless communication devices operates in a full duplex mode. Generally, full duplex operation enables bi-directional communications where at least one of the wireless communication devices may transmit and receive at the same time.

MLA may be implemented in a number of ways. In some examples, MLA may be packet-based. For packet-based aggregation, frames of a single traffic flow (such as all traffic associated with a given traffic identifier (TID)) may be sent concurrently across multiple communication links. In some other examples, MLA may be flow-based. For flow-based aggregation, each traffic flow (such as all traffic associated with a given TID) may be sent using a single one of multiple available communication links. As an example, a single STA MLD may access a web browser while streaming a video in parallel. The traffic associated with the web browser access may be communicated over a first communication link while the traffic associated with the video stream may be communicated over a second communication link in parallel (such that at least some of the data may be transmitted on the first channel concurrently with data transmitted on the second channel).

In some other examples, MLA may be implemented as a hybrid of flow-based and packet-based aggregation. For example, an MLD may employ flow-based aggregation in situations in which multiple traffic flows are created and may employ packet-based aggregation in other situations. The determination to switch among the MLA techniques or modes may additionally or alternatively be associated with other metrics (such as a time of day, traffic load within the network, or battery power for a wireless communication device, among other factors or considerations).

To support MLO techniques, an AP MLD and a STA MLD may exchange supported MLO capability information (such as supported aggregation type or supported frequency bands, among other information). In some examples, the exchange of information may occur via a beacon signal, a probe request or probe response, an association request or an association response frame, a dedicated action frame, or an operating mode indicator (OMI), among other examples. In some examples, an AP MLD may designate a given channel in a given band as an anchor channel (such as the channel on which it transmits beacons and other management frames). In such examples, the AP MLD also may transmit beacons (such as ones which may contain less information) on other channels for discovery purposes.

MLO techniques may provide multiple benefits to a WLAN. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the ON time of a modem, which may benefit a wireless communication device in terms of power consumption. Another benefit of MLO is the increased multiplexing opportunities in the case of a single BSS. For example, multi-link aggregation may increase the number of users per multiplexed transmission served by the multi-link AP MLD.

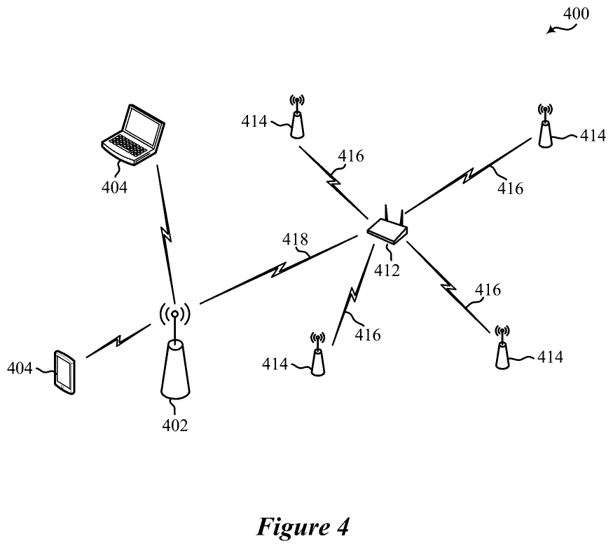

FIG. 4 shows a pictorial diagram of another example wireless communication network 400. According to some aspects, the wireless communication network 400 can be an example of a mesh network, an IoT network or a sensor network in accordance with one or more of the IEEE 802.11 family of wireless communication protocol standards (including the 802.11ah amendment). The wireless network 400 may include multiple wireless communication devices 414. The wireless communication devices 414 may represent various devices such as display devices (for example, TVs, computer monitors, navigation systems, among others), music or other audio or stereo devices, remote control devices (“remotes”), printers, kitchen or other household appliances, among other examples.

In some examples, the wireless communication devices 414 sense, measure, collect or otherwise obtain and process data and then transmit such raw or processed data to an intermediate device 412 for subsequent processing or distribution. Additionally or alternatively, the intermediate device 412 may transmit control information, digital content (for example, audio or video data), configuration information or other instructions to the wireless communication devices 414. The intermediate device 412 and the wireless communication devices 414 can communicate with one another via wireless communication links 416. In some examples, the wireless communication links 416 include Bluetooth links or other PAN or short-range communication links.

In some examples, the intermediate device 412 also may be configured for wireless communication with other networks such as with a Wi-Fi WLAN or a wireless (for example, cellular) wide area network (WWAN), which may, in turn, provide access to external networks including the Internet. For example, the intermediate device 412 may associate and communicate, over a Wi-Fi link 418, with an AP 402 of a WLAN network, which also may serve various STAs 404. In some examples, the intermediate device 412 is an example of a network gateway, for example, an IoT gateway. In such a manner, the intermediate device 412 may serve as an edge network bridge providing a Wi-Fi core backhaul for the IoT network including the wireless communication devices 414. In some examples, the intermediate device 412 can analyze, preprocess and aggregate data received from the wireless communication devices 414 locally at the edge before transmitting it to other devices or external networks via the Wi-Fi link 418. The intermediate device 412 also can provide additional security for the IoT network and the data it transports.

Aspects of transmissions may vary according to a distance between a transmitter (for example, an AP 102 or a STA 104) and a receiver (for example, another AP 102 or STA 104). Wireless communication devices may generally benefit from having information regarding the location or proximities of the various STAs 104 within the coverage area. In some examples, relevant distances may be determined (for example, calculated or computed) using RTT-based ranging procedures. Additionally, in some examples, APs 102 and STAs 104 may perform ranging operations. Each ranging operation may involve an exchange of fine timing measurement (FTM) frames (such as those defined in the 802.11az amendment to the IEEE family of wireless communication protocol standards) to obtain measurements of RTT transmissions between the wireless communication devices.

### Example Multi-Link Devices

Some wireless networks (e.g., extremely high throughput (EHT) networks) may allow devices (e.g., which may be referred to as multi-link devices (MLDs)) to communicate via two or more communication links simultaneously, for example, using multi-link aggregation (MLA).

A MLD refers to a single device or equipment that includes two or more station (STA) instances or entities, implemented in a physical (PHY)/medium access control (MAC) layer and configured to communicate on separate wireless links. In some cases, each MLD may include a single higher layer entity, such as a MAC service access point (SAP) that may assign MAC protocol data units (MPDUs) for transmission by the separate STA instances.

In some wireless networks, an access point (AP) MLD may communicate with a non-AP MLD. The AP MLD and the non-AP MLD may include STA entities (e.g., hereinafter also referred to simply as STAs or wireless STAs) that may communicate with associated STAs of another MLD. In the AP MLD, the STAs may be AP STAs (e.g., STAs serving as APs or simply APs). In the non-AP MLD, the STAs may be non-AP STAs (e.g., STAs not serving as APs).

In some wireless networks, a multi-link operation (MLO) framework accounts for MLDs with a variety of capabilities, including, for example, MLDs with loose coordination between STA instances. This may be the case, for example, when (for example, for performance and modular efficiency) multiple STAs of the MLD are implemented using a separate hardware (e.g., different chips or chipsets) and a speed of communication between the hardware of the different STAs within the MLD is limited. In other words, AP STAs in lower MAC layer devices (e.g., STA instances) may not have a fast communication link between them. However, this may not be the case on the non-AP MLD side, in which the hardware for both STA instances of the non-AP MLD is implemented via a same chip/chipset. In contrast, an AP MLD may include STA instances implemented on different chips.

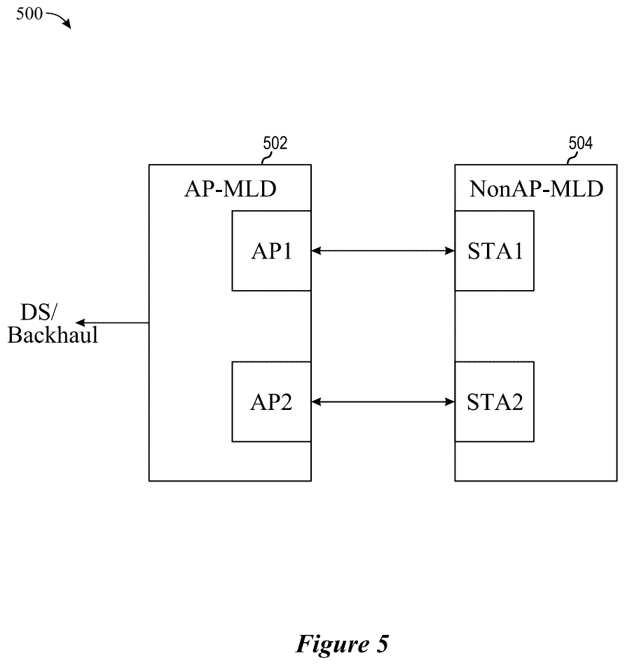

FIG. 5 shows a block diagram of an example MLD deployment 500. As shown, an AP MLD 502 communicates with a non-AP MLD 504. Each of the AP MLD 502 and the non-AP MLD 504 may include at least two STA entities that may communicate with associated STAs of another MLD. In the AP MLD 502, the STAs may be AP STAs (e.g., STAs serving as APs or simply “APs” such as AP 1 and AP 2). In the non-AP MLD 504, the STAs may be non-AP STAs (e.g., STAs not serving as Aps such as STA 1 and STA 2). As also described above, MLDs may utilize MLA (e.g., which includes packet level aggregation), whereby MPDUs from a same traffic ID (TID) may be sent via two or more wireless links.

Various modes of communication may be employed in MLD implementations. For example, the MLD may communicate in an asynchronous (Async) mode or a synchronous (Sync) mode. The Async mode provides flexibility to adapt to channel loading, allowing the MLD to perform channel access, transmit, and receive data via multiple links asynchronously. The Sync mode may be preferred, however, if radio frequency (RF) leakage exists between channels, because synchronized transmission on all links is unaffected by RF leakage.

In the Async mode, a STA/AP may count down (e.g., via a random backoff (RBO)) on both wireless links. A physical layer convergence protocol (PLCP) protocol data units (PPDU) start/end may happen independently on each of the wireless links. As a result, the Async mode may potentially provide latency and aggregation gains. In certain cases, relatively complex (and costly) filters may be needed (e.g., in the case of 5 gigahertz (GHz)+6 GHz aggregation).

In the Sync mode, a STA/AP may perform a backoff countdown on multiple wireless links as part of a channel access procedure. If a first link gains access to the medium through the channel access procedure, multiple links may transmit PPDUs at the same time. Accordingly, the Sync mode may need some restrictions to minimize in-device interference.

The Sync mode may work in 5 GHz+6 GHz aggregation and may require relatively low-filter performance, while still providing latency and aggregation gains. However, due to that STA's tiled architecture, this latency and aggregation gains may be hard to achieve.

Another mode of communication may include a Basic (for example, multi-primary with single link transmission) mode. In the Basic mode, a STA/AP may count down on both wireless links. However, transmission may only occur on the wireless link that gains access to the medium. The other wireless link may be blocked by in-device interference greater than −62 decibels per milliwatt (dBm). No aggregation gains may be realized in the Basic mode.

### Example Extremely High Throughput (EHT): Indication of Link Information for Retrieving Downlink Bus

Multi-link devices (MLDs) are capable of a multi-link operation (MLO). A MLD refers to a single device or equipment that includes two or more station (STA) instances or entities, implemented in a physical (PHY)/medium access control (MAC) layer and configured to communicate on separate wireless links. In some networks (e.g., extremely high throughput (EHT) networks), an access point (AP) MLD may communicate with a non-AP MLD. The AP MLD and the non-AP MLD may include STA entities (e.g., STAs or wireless STAs) that may communicate with associated STAs of another MLD.

One type of MLO is multi-link aggregation (MLA), where traffic associated with a single STA is simultaneously transmitted across multiple communication links in parallel to maximize the utilization of available resources to achieve a higher throughput. The MLA may be implemented in a number of ways. In some examples, the MLA may be packet-based. For packet-based aggregation, frames of a single traffic flow (such as all traffic associated with a given traffic identifier (TID)) may be sent concurrently across multiple communication links. In some other examples, MLA may be flow-based. For flow-based aggregation, each traffic flow (such as all traffic associated with a given TID) may be sent using a single one of multiple available communication links.

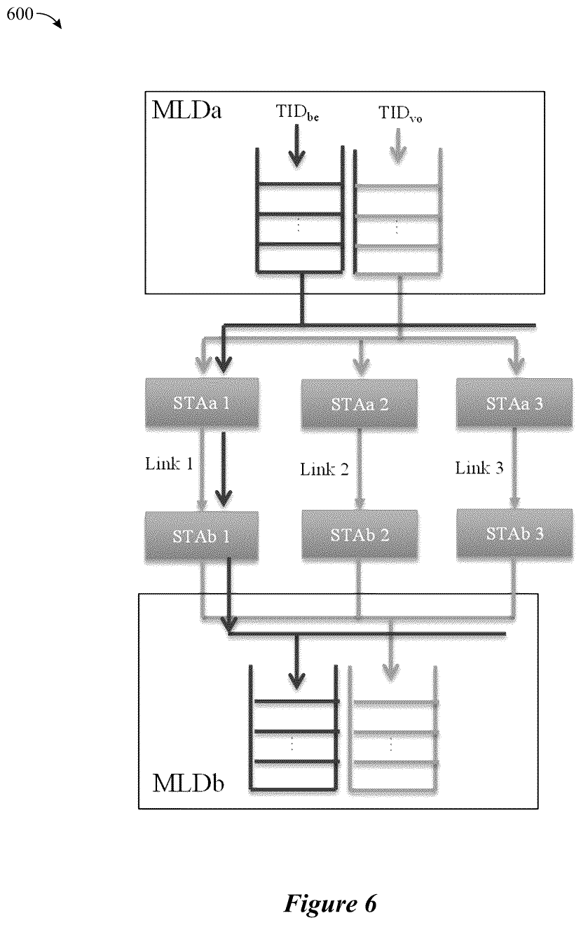

Currently, TID-to-link feature maps a TID to one or more links (e.g., between different STAs associated with different MLDs of FIG. 6). For example, as shown in a diagram 600 of FIG. 6, the MLDs include MLDa and MLDb. The multiple STAs associated with the MLDa include STAa 1, STAa 2, and STAa 3. The multiple STAs associated with the MLDb include STAb 1, STAb 2, and STAb 3. A first link (e.g., link 1) is between the STAa 1 and the STAb 1. A second link (e.g., link 2) is between the STAa 2 and the STAb 2. A third link (e.g., link 3) is between the STAa 3 and the STAb 3. The frames belonging to the TID are sent on the mapped link(s).

There are different modes associated with the TID-to-link feature. For example, a TID-to-link mapping (TTLM) mode 3 may allow for disjoint mapping between different TIDs and different links. In this mode, a first subset of TIDs (e.g., of a set of TIDs) are mapped to a first set of links and another subset of TIDs (e.g., a second subset of TIDs of the set of TIDs, or remaining subset of TIDs of the set of TIDs) are mapped to a second set of links (e.g., which is different from the first set of links). In another example, a TTLM mode 2 may allow mapping of all TIDs to a subset of links (e.g., first subset of links) and a subset of TIDs to additional links (e.g., different from the first subset of links).

In some cases, the non-AP MLD may have negotiated the TTLM mode 2 or mode 3 with the AP MLD for downlink operations or for uplink/downlink operations. In such cases, when the AP MLD may have buffered traffic for the non-AP MLD (e.g., the AP MLD has buffered BU(s) with TID(s) that are not mapped to all enabled links for the non-AP MLD), the AP MLD may need to indicate which link(s) the BUs or traffic belong to for the non-AP MLD. The AP MLD may send such traffic information (i.e., including which link(s) the BUs or traffic belong to) via a multi-link traffic indication element in a beacon frame. For example, in TIM element (e.g., carried in the beacon frame), the AP MLD may set the bit matching association identifier (AID) of the non-AP MLD to 1 (e.g., when all STAs of the non-AP MLD are in sleep mode) to indicate that there is traffic buffered for the non-AP MLD. However, this may not convey full information to the non-AP MLD, since there is an ambiguity on which link(s) the non-AP MLD may need to wake-up to retrieve the BUs. In some cases, the TIM element may identify one or more non-AP MLDs (e.g., for which it has BUs and have performed non-mode 1 mapping).

In some cases, the multi-link traffic indication element may help to identify which link(s) the TID(s) of the buffered traffic maps to (for example, if a non-AP MLD has performed multi-link association with the AP MLD on 3 links (link 1, link 2 and link 3) and the AP MLD has buffered traffic for the non-AP MLD, then the multi-link traffic element can provide information about which links the BUs map to based on the TTLM negotiated by the non-AP MLD with the AP MLD).

In some cases, the multi-link traffic indication element can have a very large size (e.g., due to its design and format). If the beacon frame carries the multi-link traffic indication element of the large size, this will cause a size of the beacon frame to become very large. Currently, legacy STAs have difficulty processing a large beacon frame (e.g., which has a size more than 1800 bytes). Therefore, it is critical to limit the size of the beacon frame. In one example, the size of the beacon frame may be reduced by moving the multi-link traffic indication element out of the beacon frame to another frame. In another example, the size of the beacon frame may be reduced by moving some information (e.g., operational parameters and/or capability information associated with an AP) carried by the beacon frame to another frame. In another example, the size of the beacon frame may be reduced by moving all information (e.g., the operational parameters and/or capability information associated with the AP), belonging to a certain generation of Wi-Fi, carried by the beacon frame to another frame.

Aspects of the present disclosure provide apparatuses, methods, processing systems, and computer-readable mediums for using one or more second frames (other than a first frame such as a first beacon frame) by a first wireless device or node (e.g., an AP or an AP MLD) for carrying one or more fields or elements (such as one or more multi-link traffic indication elements that may have been previously carried by the first beacon frame). In some cases, any two second frames may carry same or different types of data or information. In one example, a second frame may be a second beacon frame, a link recommendation frame (also known as a link indication frame), or any new frame (for example, a beacon extension frame or a beacon follow-up frame). For example, the first wireless device may send the first frame to one or more second wireless devices or nodes (e.g., non-AP STAs or non-AP MLDs), and then send the one or more second frames carrying the one or more fields or elements to the one or more second wireless devices or nodes. The first frame may indicate a presence of the one or more second frames, certain fields or elements in the one or more second frames, and/or certain attributes (e.g., transmission periodicity) corresponding to the one or more second frames. In some cases, at least one second frame may have a periodicity that is different from the periodicity of the first frame.

In certain aspects, at least one field or element (e.g., a field A) carried in the first frame is associated with a first set of one or more attributes. The first set of one or more attributes may include a first format, a first interpretation, a first (type of) encoding or a first granularity level. For example, the field A carried in the first frame may be associated with a format A, the first type of encoding and a low granularity level. The field A when carried in the second frame may be associated with a second set of one or more attributes. The second set of one or more attributes may include a second format, a second interpretation, a second (type of) encoding or a second granularity level. For example, the field A carried in the second frame may be associated with a format B (which is different from the format A), the second type of encoding (which is different from the the first type of encoding) and a high granularity level (which is better than the low granularity level).

Currently, the link recommendation frame includes a single multi-link traffic indication element for indicating link recommendations for one or more non-AP MLDs. According to the present disclosure, in some cases, the link recommendation frame may also include the multi-link traffic indication element having a different interpretation of the multi-link traffic element (e.g., than the interpretation or usage of the multi-link traffic indication being used in some other frame) —i.e., for providing traffic indication to one or more non-AP MLDs. It is possible that the link recommendation frame carries multiple multi-link traffic indication elements and these multi-link traffic indication elements can be used to indicate the link recommendation to one or more non-AP MLDs as well as the traffic information for a different set of one or more non-AP MLDs.

In one example, a link recommendation frame (e.g., from an AP MLD to a non-AP MLD) may include a multi-link traffic indication element which may indicate the link recommendations or the traffic information for one or more non-AP MLDs. In this example case, the link recommendation frame or the multi-link traffic indication element may include a bit which may indicate the interpretation of the multi-link traffic element—i.e., whether the multi-link traffic indication element includes the link recommendations or the traffic information.

In another example, a link recommendation frame (e.g., from an AP MLD to a non-AP MLD) may include two multi-link traffic indication elements, which may indicate the link recommendations as well as the traffic information for the different sets of non-AP MLDs. In this example case, a first multi-link traffic indication element of the link recommendation frame may include a bit (which may be set to zero) to indicate that the first multi-link traffic indication element must be interpreted as includes the link recommendations for a first set of one or more non-AP MLDs. A second multi-link traffic indication element of the link recommendation frame may include a bit (which may be set to one) which may indicate that the second multi-link traffic indication element must be interpreted as includes the traffic information for a second set of one or more non-AP MLDs.

In certain aspects, an order in which the one or more fields or elements appear in the at least one second frame can determine a role of the one or more fields or elements in the at least one second frame. For example, the order in which the one or more multi-link traffic indication elements appear in the link recommendation frame can determine a role of the one or more multi-link traffic indication elements in the link recommendation frame. For example, a first multi-link traffic indication element in the link recommendation frame provides link indication to a first set of one or more non-AP MLDs while another multi-link traffic indication element that appears second in the link recommendation frame provides traffic indication to a second set of one or more non-AP MLDs.

In certain aspects, the first frame is transmitted from the first wireless device to the second wireless device and includes the one or more fields or elements. The one or more fields or elements of the first frame may indicate that the one or more second frames (e.g., from the first wireless device to the second wireless device) that follows the first frame may carry a certain type of information or data (e.g., traffic indication, link information, capabilities, and/or operational parameters). For example, the beacon frame may have an indication that the link recommendation frame that follows the beacon frame provides traffic indication to one or more non-AP MLDs.

In certain aspects, the link recommendation frame that follows a particular beacon frame (such as delivery traffic indication message (DTIM) beacon frame) always provides link recommendation for one or more non-AP MLDs. In such cases, if the AP MLD also has traffic indication for one or more different non-AP MLDs, then the link recommendation frame that it transmits will carry two multi-link traffic indication elements, that is, one multi-link traffic indication element for providing link recommendation and other multi-link traffic indication element for traffic indication.

In certain aspects, a first wireless device (such as the AP MLD or other device) may send a link recommendation frame with one or more multi-link traffic indication elements to a broadcast address.

In certain aspects, the first wireless device may send the beacon frame to the one or more second wireless devices, and then send the link recommendation frame to the one or more second wireless devices. For example, the AP MLD may transmit the link recommendation frame with the one or more multi-link traffic indication elements, after the beacon frame has been transmitted and the non-AP MLD has successfully negotiated the TTLM with the AP MLD.

In certain aspects, the first frame may include one or more bits which may indicate that the one or more second frames may carry one or more types of data. For example, the beacon frame may include one or more bits which may indicate that the link recommendation frame being transmitted after the beacon frame may carry the link recommendations for the different STAs, the traffic information for the different STAs, or both. In such cases, if the link recommendation frame carries only one multi-link traffic indication element, then it may not include a bit indication to indicate if it provides link recommendation or traffic indication. In such other cases, if two multi-link traffic indication elements are included in the link recommendation frame, then explicit bits to indicate whether the link recommendation frame includes the link recommendations for the different non-AP MLDs will be needed.

In certain aspects, the one or more second frames may be transmitted within a certain time period (e.g., within an interval associated with the first frame) or after the certain time period from the transmission of the first frame. For example, the link recommendation frame may be transmitted within a predetermined time period or after the predetermined time period from the transmission of the beacon frame. In some cases, when the link recommendation frame with the one or more multi-link traffic indication elements is transmitted after the beacon frame within the predetermined time period, the link recommendation frame may only carry the link recommendations for one or more non-AP MLDs. At all other times, the link recommendation frame may carry the traffic information for one or more non-AP MLDs.

In certain aspects, when the link recommendation frame with the one or more multi-link traffic indication elements is transmitted during a DTIM interval associated with the beacon frame, the link recommendation frame may only carry the link recommendations for one or more non-AP MLDs. At all other times, the link recommendation frame may only carry the traffic information for the different STAs.

In certain aspects, the link recommendation frame with the one or more multi-link traffic indication elements sent during the DTIM interval (which is associated with the beacon frame) may have the traffic information for one or more non-AP STAs as well as the link recommendations for one or more non-AP MLDs. In such cases, one of the multi-link traffic indication elements of the link recommendation frame may include a bit to indicate if the link recommendation frame carries the traffic information for one or more non-AP MLDs. In some cases, the beacon frame (which is transmitted prior to the link recommendation frame) may include a bit to indicate if the link recommendation frame will carry the traffic information for the different STAs.

In certain aspects, an order of the one or more fields or elements in the one or more second frames may indicate a type of data carried by the second frame. For example, when the link recommendation frame may include two multi-link traffic indication elements, an order of the two multi-link traffic indication elements in the link recommendation frame may indicate content associated with the two multi-link traffic indication elements. In one example, a first multi-link traffic indication element in the link recommendation frame may indicate the traffic information for the different STAs and a second multi-link traffic indication element in the link recommendation frame may indicate the link recommendations for the different STAs. In another example, a first multi-link traffic indication element in the link recommendation frame may indicate the link recommendations for the different STAs and a second multi-link traffic indication element in the link recommendation frame may indicate the traffic information for the different STAs.

In certain aspects, a presence of the one or more fields or elements in the one or more second frames or an absence of the one or more fields or elements in the one or more second frames may indicate a type of data carried by the one or more second frames. For example, when the link recommendation frame may include two multi-link traffic indication elements, the presence or absence of certain fields or elements within the link recommendation frame may indicate content associated with the two multi-link traffic indication elements.

In certain aspects, the link recommendation frame with the one or more multi-link traffic indication elements may be carried in a non-legacy PHY protocol data unit (PPDU) or a new PPDU format, so that legacy STAs (e.g., of the non-AP MLD) are not confused to see a broadcast frame during a non-DTIM beacon.

In certain aspects, the first frame and the one or more second frames may be transmitted based on a same set of transmission parameters (such as a transmission data rate, a time interval, a bandwidth, a frame format, etc.). In certain aspects, the first frame and the at least one second frame may be transmitted based on different sets of transmission parameters (such as different transmission data rates, different time intervals, different bandwidths, different frame formats). For example, the link recommendation frame with the one or more multi-link traffic indication elements may be carried at a different data rate (perhaps a higher data rate) than that compared to the beacon frame.

In certain aspects, the link recommendation frame with the one or more multi-link traffic indication elements may maintain a packet number or a sequence number or both associated with transmission of group addressed frames (for example, a beacon frame).

In certain aspects, the link recommendation frame with the one or more multi-link traffic indication elements may have a receiver address set to a special address so that legacy STAs (e.g., of the non-AP MLD) are not confused to see a frame sent to broadcast address during a non-DTIM beacon.

In certain aspects, the link recommendation frame with the one or more multi-link traffic indication elements may be sent in a short interframe space (SIFS) after the beacon frame, so that the one or more non-AP MLDs for which the AP MLD has buffered traffic do not have to be awake for a long period of time to receive an link indication for downlink traffic. Such non-AP MLDs may be the ones that have negotiated TTLM mode 2 or mode 3 and have the corresponding bit in the TIM element carried in the beacon frame set to 1.

In certain aspects, the link recommendation frame with the one or more multi-link traffic indication elements may not provide link recommendation and traffic announcement/information for the same set of non-AP MLDs. In certain aspects, the link recommendation frame with the one or more multi-link traffic indication elements may be a protected management frame.

In certain aspects, the at least one second wireless device may determine content or intention of the at least one received second frame sent from the first wireless device, based on a presence or absence of certain field(s)/element(s) in the at least one second frame, values in the certain field(s)/element(s) or an order in which certain field(s)/element(s) appear in the at least one second frame. For example, the non-AP MLD may determine content or intention of the received link recommendation frame (e.g., with the one or more multi-link traffic indication elements) being sent from the AP MLD, based on a presence or absence of certain field(s)/element(s) in the link recommendation frame, values in the certain field(s)/element(s) or an order in which certain field(s)/element(s) appear in the link recommendation frame.

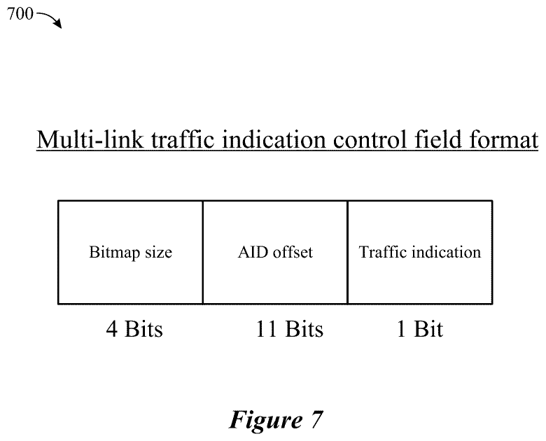

One example of a multi-link traffic indication control field format is shown in a diagram 700 of FIG. 7. As shown, one field of the multi-link traffic indication control field format may indicate traffic information.

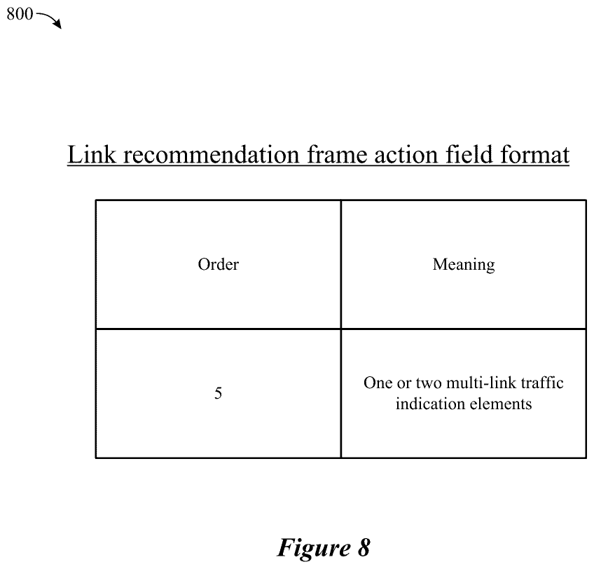

One example of a link recommendation frame action field format is shown in a diagram 800 of FIG. 8. As shown, the link recommendation frame action field format may include one or two multi-link traffic indication elements.

In certain aspects, an AP affiliated with an AP MLD shall transmit a link recommendation frame that includes the multi-link traffic indication element after a transmitted beacon frame if all of the following conditions are met: a) at least one of the associated non-AP MLDs has successfully negotiated a TTLM (Negotiation of TTLM) with the AP MLD for DL or bidirectional traffic and not all TIDs are mapped to all enabled links, b) the AP MLD has buffered BU(s) with TID(s) that are not mapped to all the enabled links for the non-AP MLD(s). In the above-mentioned link recommendation frame, the traffic indication subfield of the multi-link traffic indication element shall be set to 1.

In certain aspects, an AP MLD shall set dot11MultiLinkTrafficIndicationActivated to true if any of the following conditions is met: 1) The AP MLD intends to provide link recommendations in a beacon frame to retrieve individually addressed buffered BUs to at least one associated non-AP MLD that has all TIDs mapped to all the enabled links and the AP MLD has buffered BU(s) for that non-AP MLD. Otherwise, the AP MLD shall set the dot11MultiLinkTrafficIndicationActivated to false.

In certain aspects, when the multi-link traffic indication element is carried in a link recommendation frame, the traffic indication field is set to 1 to indicate that the element identifies the link(s) where the non-AP MLD(s) identified via the AID Bitmap element can retrieve DL BUs. Otherwise, the field is set to 0. The field is set to 0 when the element is carried in a beacon frame.

In certain aspects, the per-Link Traffic Indication Bitmap n subfield is defined (Per-Link Traffic Indication Bitmap n subfield format). When the multi-link traffic indication element is in a beacon frame, each per-link traffic indication bitmap n subfield indicates link recommendation for a non-AP MLD that has all TIDs mapped to all the enabled links.

In certain aspects, in a beacon frame when the per-link traffic indication bitmap n subfield corresponds to a non-AP MLD that is in the default mapping mode or has negotiated a TTLM with an AP MLD and all TIDs are mapped to all the enabled links, a value of 1 in the bit position i in the bitmap indicates that the link with the link ID equal to i is recommended for retrieving buffered BU(s).

In certain aspects, in a link recommendation frame containing this element with the traffic indication subfield is set to 1, when the per-link traffic indication bitmap n subfield corresponds to a non-AP MLD that has successfully negotiated a TTLM or is in the advertised TTLM wherein not all TIDs are mapped to all the enabled links, a value of 1 in the bit position i in the bitmap that corresponds to a link on which a non-AP STA affiliated with a non-AP MLD is operating indicates that there is buffered BU(s) with TID(s) mapped to the link with the link ID equal to i or MMPDU(s); a value of 0 in a bit position in the bitmap indicates that there is no buffered BU(s) with TID(s) mapped to the corresponding link nor MMPDU(s).

In certain aspects, in a link recommendation frame containing this element with the traffic indication subfield is set to 0, when the per-link traffic indication bitmap n subfield corresponds to a non-AP MLD, a value of 1 in the bit position i in the bitmap indicates that the link with the link ID equal to i is recommended for frame exchanges both in DL and in UL (traffic indication); a value of 0 in the bit position i in the bitmap indicates that the link with the link ID equal to i is not recommended for frame exchanges both in DL and in UL (traffic indication).

In certain aspects, link indication frame includes two multi-link traffic indication elements when one of the multi-link traffic indication elements provides link recommend to the non-AP MLD(s) identified in the multi-link traffic indication element while the other multi-link traffic indication element indicates the link(s) where the non-AP MLD(s) identified in the multi-link traffic indication element can retrieve DL BUs.

In certain aspects, an AP affiliated with an AP MLD may schedule for transmission a link recommendation frame to provide link recommendation for a set of non-AP MLDs as follows: address 1 field of the link recommendation frame shall be set to the broadcast address, a traffic indication subfield of the multi-link traffic indication element shall be set to 0.

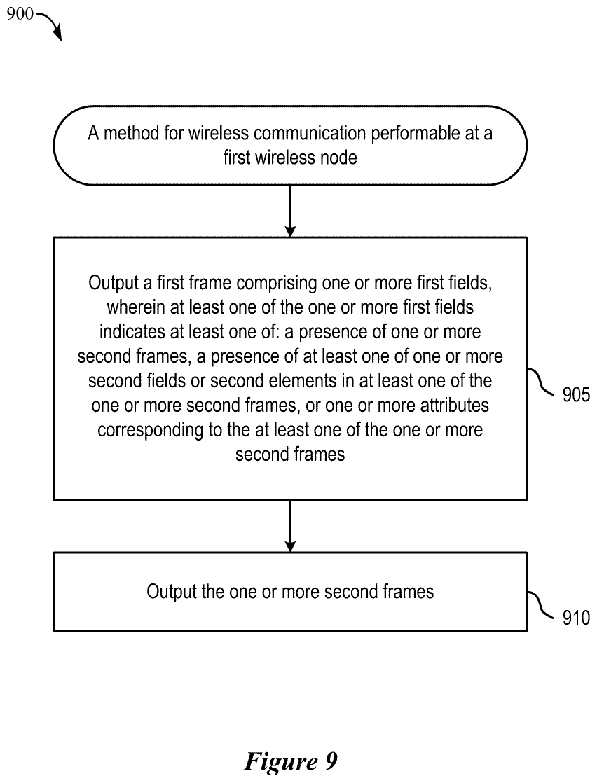

FIG. 9 shows an example of a process or method 900 of wireless communication performable at a first wireless device or wireless node.

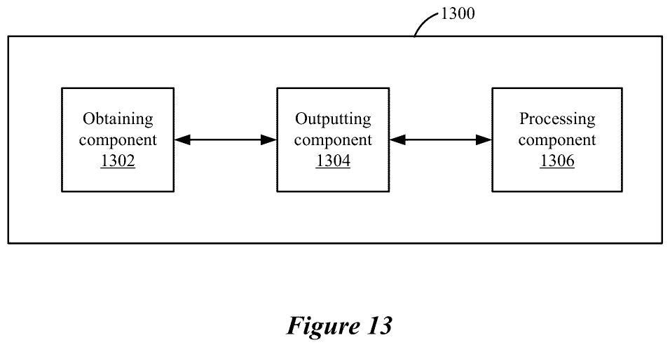

In certain aspects, the operations of the method 900 may be implemented by the first wireless device or wireless node such as a wireless AP or its components as described herein. For example, the method 900 may be performed by a wireless communication device, such as a wireless communication device 1300 described with reference to FIG. 13, operating as or within the wireless AP. In some examples, the method 900 may be performed by the wireless AP, such as one of the wireless APs 102 described with reference to FIG. 1.

In certain aspects, the operations of the method 900 may be implemented by the first device such as a wireless STA or its components as described herein. For example, the method 900 may be performed by a wireless communication device, such as a wireless communication device 1300 described with reference to FIG. 13, operating as or within the wireless STA. In some examples, the method 900 may be performed by the wireless STA such as one of the STAs 104 described with reference to FIG. 1.

Method 900 begins at step 905 with outputting a first frame comprising one or more first fields, wherein at least one of the one or more first fields indicates at least one of: a presence of one or more second frames, a presence of at least one of one or more second fields or second elements in at least one of the one or more second frames, or one or more attributes corresponding to the at least one of the one or more second frames.

Method 900 then proceeds to step 910 with outputting the one or more second frames.

In some aspects, the first frame is a first beacon frame.

In some aspects, the at least one of the one or more second frames is at least one of: a second beacon frame, a new frame, a beacon extension frame, a follow-up beacon frame, or a link recommendation frame.

In some aspects, the one or more second frames are outputted within a first time period from outputting of the first frame.

In some aspects, the one or more second frames are outputted after a first time period from outputting of the first frame.

In some aspects, the first frame is outputted for transmission using a first set of one or more transmission parameters comprising at least one of a first transmission periodicity, a first transmission data rate, a first bandwidth, or a first frame format; and the one or more second frames are outputted for transmission using a second set of one or more transmission parameters comprising at least one of a second transmission periodicity, a second transmission data rate, a second bandwidth, or a second frame format.

In some aspects, a value of the first transmission periodicity is same as a value of the second transmission periodicity.

In some aspects, a value of the first transmission periodicity is different from a value of the second transmission periodicity.

In some aspects, a value of the first transmission data rate is same as a value of the second transmission data rate.

In some aspects, a value of the first transmission data rate is different from a value of the second transmission data rate.

In some aspects, a value of the first bandwidth is same as a value of the second bandwidth.

In some aspects, a value of the first bandwidth is different from a value of the second bandwidth.

In some aspects, the first frame format is same as the second frame format.

In some aspects, the first frame format is different from the second frame format.

In some aspects, the at least one of the one or more first fields further indicates an absence of one or more third fields in the at least one of the one or more second frames.

In some aspects, at least one of: the presence of the one or more second fields or second elements in the at least one of the one or more second frames or the absence of the one or more third fields in the at least one of the one or more second frames indicates a type of data carried by the at least one of the one or more second frames.

In some aspects, an order of the one or more second fields or second elements in the second frame indicates a type of data carried by the at least one of the one or more second frames.

In some aspects, one or more values within the one or more second fields or second elements in the at least one of the one or more second frames indicates a type of data carried by the at least one of the one or more second frames.

In some aspects, the first device is an AP MLD.

In some aspects, the method 900 further includes outputting for transmission the first frame to one or more second devices, and wherein one of the one or more second devices is a non-AP wireless STA or a non-AP MLD.

In some aspects, one of the one or more attributes is a periodicity of the at least one of the one or more second frames.

In some aspects, the at least one of the one or more first fields further indicates a type of data or information carried by the at least one of the one or more second frames.

In some aspects, the first frame is outputted to a broadcast address.

In some aspects, the first frame is associated with at least one of: a first packet number or a first sequence number; and the at least one of the one or more second frames is associated with the at least one of: the first packet number or the first sequence number.

In some aspects, at least one field or element carried in the first frame is associated with a first set of one or more attributes comprising at least one of a first format, a first type of encoding, a first interpretation or a first granularity level; the at least one same field or element carried in the second frame is associated with a second set of one or more attributes comprising at least one of a second format, a second type of encoding, a second interpretation or a second granularity level; and the first set of one or more attributes is different from the second set of one or more attributes.

In one aspect, method 900, or any aspect related to it, may be performed by an apparatus, such as a wireless communications device 1300 of FIG. 13, which includes various components operable, configured, or adapted to perform the method 900. The wireless communications device 1300 is described below in further detail.

Note that FIG. 9 is just one example of a method, and other methods including fewer, additional, or alternative steps are possible consistent with this disclosure.

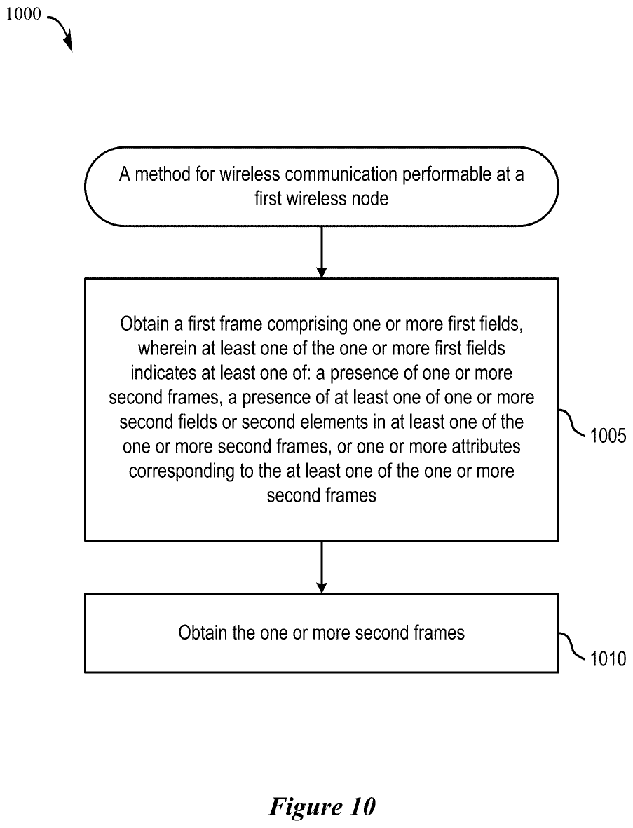

FIG. 10 shows an example of a process or method 1000 of wireless communication performable at a first wireless device or wireless node.

In certain aspects, the operations of the method 1000 may be implemented by the first wireless device or wireless node such as a wireless STA or its components as described herein. For example, the method 1000 may be performed by a wireless communication device, such as a wireless communication device 1300 described with reference to FIG. 13, operating as or within the wireless STA. In some examples, the method 1000 may be performed by the wireless STA such as one of the STAs 104 described with reference to FIG. 1.

In certain aspects, the operations of the method 1000 may be implemented by the first device such as a wireless AP or its components as described herein. For example, the method 1000 may be performed by a wireless communication device, such as a wireless communication device 1300 described with reference to FIG. 13, operating as or within the wireless AP. In some examples, the method 1000 may be performed by the wireless AP, such as one of the wireless APs 102 described with reference to FIG. 1.

Method 1000 begins at step 1005 with obtaining a first frame comprising one or more first fields, wherein at least one of the one or more first fields indicates at least one of: a presence of one or more second frames, a presence of at least one of one or more second fields or second elements in at least one of the one or more second frames, or one or more attributes corresponding to the at least one of the one or more second frames.

Method 1000 then proceeds to step 1010 with obtaining the one or more second frames.

In some aspects, the first frame is a first beacon frame.

In some aspects, the at least one of the one or more second frames is at least one of: a second beacon frame, a new frame, a beacon extension frame, a follow-up beacon frame, or a link recommendation frame.

In some aspects, the at least one of the one or more first fields further indicates an absence of one or more third fields in the at least one of the one or more second frames.

In some aspects, an order of the one or more second fields or second elements in the second frame indicates a type of data carried by the at least one of the one or more second frames.

In one aspect, method 1000, or any aspect related to it, may be performed by an apparatus, such as a wireless communications device 1300 of FIG. 13, which includes various components operable, configured, or adapted to perform the method 1000. The wireless communications device 1300 is described below in further detail.

Note that FIG. 10 is just one example of a method, and other methods including fewer, additional, or alternative steps are possible consistent with this disclosure.

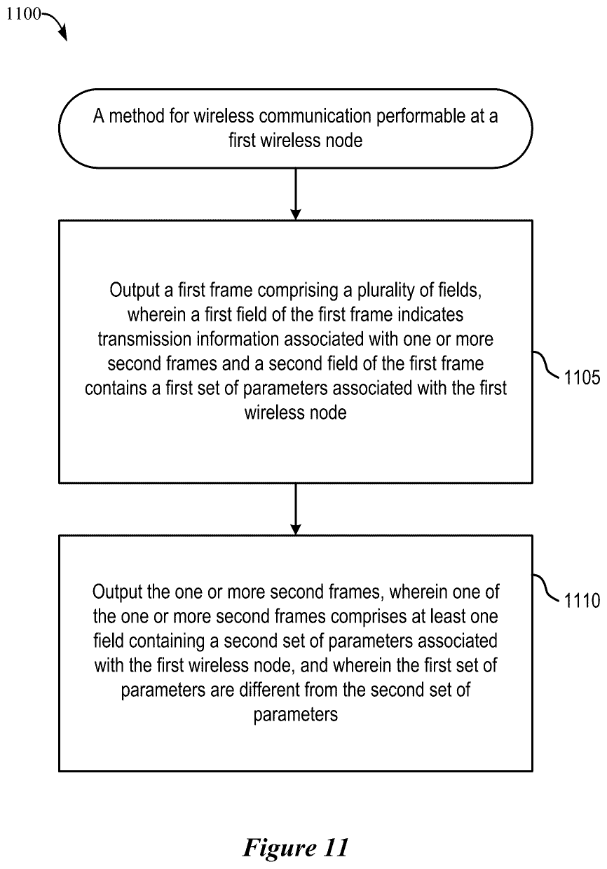

FIG. 11 shows an example of a process or method 1100 of wireless communication performable at a first wireless node.

In certain aspects, the operations of the method 1100 may be implemented by the first wireless node such as a wireless AP or its components as described herein. For example, the method 1100 may be performed by a wireless communication device, such as a wireless communication device 1300 described with reference to FIG. 13, operating as or within the wireless AP. In some examples, the method 1100 may be performed by the wireless AP, such as one of the wireless APs 102 described with reference to FIG. 1.

In certain aspects, the operations of the method 1100 may be implemented by the first wireless node such as a wireless STA or its components as described herein. For example, the method 1100 may be performed by a wireless communication device, such as a wireless communication device 1300 described with reference to FIG. 13, operating as or within the wireless STA. In some examples, the method 1100 may be performed by the wireless STA such as one of the STAs 104 described with reference to FIG. 1.

Method 1100 begins at step 1105 with outputting a first frame including a plurality of fields (e.g., to a second wireless node such as a wireless STA).

In certain aspects, a first field of the first frame may indicate transmission information associated with one or more second frames.

In certain aspects, a second field of the first frame may contain a first set of parameters associated with the first wireless node. In one example, one of the first set of parameters may indicate a type of the first wireless node (e.g., the first wireless node is a wireless AP). In another example, one of the first set of parameters may indicate that the first wireless node may belong to or is applicable for a certain Wi-Fi generation (e.g., Wi-Fi 8). In another example, the second field may correspond to a bit field carried within the first frame to indicate that the first wireless node may be a node applicable for Institute of Electrical and Electronics Engineers (IEEE) 802.11bn (or higher) family of standards. In another example, the second field may indicate that some parameters corresponding to the 802.11bn family of standards are not included in the first frame.

Method 1100 then proceeds to step 1110 with outputting the one or more second frames (e.g., to the second wireless node). One of the one or more second frames may include at least one field containing a second set of parameters associated with the first wireless node.

In one example, the second set of parameters (e.g., such as a parameter A, a parameter B, a parameter C, etc.) may be scattered across different second frames (e.g., such as a frame A, a frame B, a frame C, etc.). For instance, the frame A of the second frames (e.g., such as a broadcast probe response frame) may have a field to include the parameter A of the second set of parameters (e.g., such as operations and capabilities element), and the frame B of the second frames (e.g., such as a coordinated AP advertisement frame) may have fields to include the parameter B and the parameter C of the second set of parameters. That is, each second frame may carry different parameters from the second set of parameters.

In another example, a single second frame may have fields to include all of the second set of parameters.

In another example, some of the second frames may have fields to include some of the second set of parameters.

In certain aspects, the first set of parameters may be different from the second set of parameters. For example, the second set of parameters may include information such as ultra high reliability (UHR) operation element and UHR capability information/element (e.g., which may not be transmitted via the first frame).

In certain aspects, the transmission information associated with the one or more second frames may indicate a presence of the one or more second frames or an absence of the one or more second frames.

The presence of the one or more second frames may indicate no request for the one or more second frames is required by the first wireless node (e.g., from the second wireless node) to output the one or more second frames (e.g., to the second wireless node).

The presence of the one or more second frames may also indicate a transmission time and/or a transmission periodicity associated with the one or more second frames (e.g., to the second wireless node).

The absence of the one or more second frames may indicate a request for the one or more second frames is required by the first wireless node (e.g., from the second wireless node) to output the one or more second frames (e.g., to the second wireless node). Accordingly, in certain aspects, the first wireless node may obtain the request for the one or more second frames from the second wireless node. The one or more second frames are then outputted to the second wireless node, in accordance with the obtained request.

In certain aspects, the first frame may be a beacon frame. The one or more second frames may not be beacon frames. For example, each of the one or more second frames may be a new frame, a beacon extension frame, a follow-up beacon frame, a probe response frame, a broadcast frame, a link recommendation frame, an association response frame, a reassociation response frame, or a link reconfiguration frame.

In certain aspects, the one or more second frames may be outputted (e.g., to the second wireless node) within a first time period from outputting of the first frame (e.g., to the second wireless node).

In certain aspects, the one or more second frames may be outputted (e.g., to the second wireless node) after a first time period from outputting of the first frame (e.g., to the second wireless node).

In certain aspects, the first frame may be outputted (e.g., to the second wireless node) by using a first set of one or more transmission parameters including a first transmission periodicity, a first transmission data rate, a first bandwidth, and/or a first frame format. The one or more second frames may be outputted (e.g., to the second wireless node) by using a second set of one or more transmission parameters including a second transmission periodicity, a second transmission data rate, a second bandwidth, and/or a second frame format.

In certain aspects, a value of the first transmission periodicity is same as a value of the second transmission periodicity; a value of the first transmission data rate is same as a value of the second transmission data rate; a value of the first bandwidth is same as a value of the second bandwidth; and/or the first frame format is same as the second frame format.

In certain aspects, a value of the first transmission periodicity is different from a value of the second transmission periodicity; a value of the first transmission data rate is different from a value of the second transmission data rate; a value of the first bandwidth is different from a value of the second bandwidth; and/or the first frame format is different from the second frame format.

In certain aspects, one of the one or more second frames may include a plurality of fields. An order of the plurality of fields in a particular one of the one or more second frames indicates a type of data carried by the particular one of the one or more second frames.

In certain aspects, one or more values within the at least one field indicates a type of data carried by the one or more second frames.

In certain aspects, a third field of the first frame indicates a type of data or information carried by the one or more second frames.

In certain aspects, the first frame and/or the one or more second frames may be outputted (e.g., to the second wireless node) based on a broadcast address.

In certain aspects, the first frame is associated with a first packet number and/or a first sequence number. Each of the one or more second frames may be associated with the first packet number and/or the first sequence number.

In certain aspects, at least one of the plurality of fields in the first frame may be associated with a first set of one or more attributes including a first format, a first type of encoding, a first interpretation and/or a first granularity level. The at least one field in the one or more second frames may be associated with a second set of one or more attributes including a second format, a second type of encoding, a second interpretation and/or a second granularity level. The first set of one or more attributes may be different from the second set of one or more attributes.

In certain aspects, a fourth field of the first frame may contain one or more of the second set of parameters (e.g., which may generally be carried via the second frames), when there is an update of information associated with the one or more of the second set of parameters. For instance, the first wireless node may determine there is a change or the update of the information associated with the one or more of the second set of parameters. In such cases, the first wireless node may output the one or more of the second set of parameters via the first frame (e.g., to the second wireless node) as opposed to via the second frames. For example, the first wireless node may transmit an indication of a type of the first wireless node via a beacon frame. The first wireless node may transmit parameters (e.g., such as capabilities element and operations element) associated with the first wireless node via a follow up frame (e.g., such as a broadcast probe response, beacon extension or some other frame) to the beacon frame. However, if there is an update of any information associated with at least one of the parameters, the beacon frame may carry an indication that a certain parameter has been updated. In some cases, the beacon frame may also carry the certain parameter that has been updated.

In certain aspects, a fifth field of the first frame may indicate an update of information associated with one or more of the second set of parameters.

In one aspect, method 1100, or any aspect related to it, may be performed by an apparatus, such as a wireless communications device 1300 of FIG. 13, which includes various components operable, configured, or adapted to perform the method 1100. The wireless communications device 1300 is described below in further detail.

Note that FIG. 11 is just one example of a method, and other methods including fewer, additional, or alternative steps are possible consistent with this disclosure.

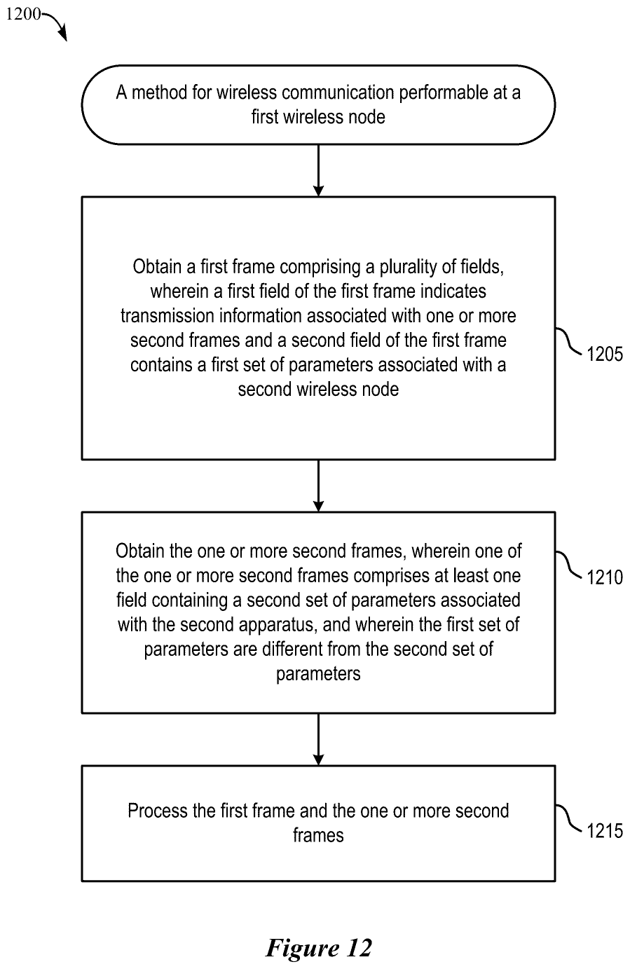

FIG. 12 shows an example of a process or method 1200 of wireless communication performable at a first wireless node.

In certain aspects, the operations of the method 1200 may be implemented by the first wireless node such as a wireless STA or its components as described herein. For example, the method 1200 may be performed by a wireless communication device, such as a wireless communication device 1300 described with reference to FIG. 13, operating as or within the wireless STA. In some examples, the method 1200 may be performed by the wireless STA such as one of the STAs 104 described with reference to FIG. 1.

In certain aspects, the operations of the method 1200 may be implemented by the first wireless node such as a wireless AP or its components as described herein. For example, the method 1200 may be performed by a wireless communication device, such as a wireless communication device 1300 described with reference to FIG. 13, operating as or within the wireless AP. In some examples, the method 1200 may be performed by the wireless AP, such as one of the wireless APs 102 described with reference to FIG. 1.

Method 1200 begins at step 1205 with obtaining a first frame including a plurality of fields (e.g., from a second wireless node such as a wireless AP).

A first field of the first frame may indicate transmission information associated with one or more second frames.

A second field of the first frame may contain a first set of parameters associated with the second wireless node. In one example, one of the first set of parameters may indicate a type of the second wireless node (e.g., the second wireless node is a wireless AP). In another example, one of the first set of parameters may indicate that the second wireless node may belong to or is applicable for a certain Wi-Fi generation (e.g., Wi-Fi 8). In another example, the second field may correspond to a bit field carried within the first frame to indicate that the second wireless node may be a node applicable for IEEE 802.11bn (or higher) family of standards. In another example, the second field may indicate that some parameters corresponding to the 802.11bn family of standards are not included in the first frame.

Method 1200 then proceeds to step 1210 with obtaining the one or more second frames (e.g., from the second wireless node). One of the one or more second frames may include at least one field containing a second set of parameters associated with the second wireless node.

In one example, each of the one or more second frames may carry different parameters from the second set of parameters.

In another example, a single second frame may carry all of the second set of parameters.

In another example, some of the second frames may carry some of the second set of parameters.

In certain aspects, the first set of parameters may be different from the second set of parameters. For example, the second set of parameters may include information such as UHR operation element and UHR capability information/element (e.g., which may not be transmitted via the first frame).

Method 1200 then proceeds to step 1215 with processing the first frame and the one or more second frames. For example, the first wireless node may process the first frame prior to obtaining the one or more second frames. In another example, the first wireless node may process the first frame prior to processing the one or more second frames.

In certain aspects, the transmission information associated with the one or more second frames may indicate a presence of the one or more second frames or an absence of the one or more second frames.

The presence of the one or more second frames may indicate no request for the one or more second frames is required from the first wireless node (e.g., by the second wireless node for transmitting the one or more second frames).

The presence of the one or more second frames may also indicate a transmission time and/or a transmission periodicity associated with the one or more second frames (e.g., from the second wireless node).

The absence of the one or more second frames may indicate a request for the one or more second frames is required from the first wireless node (e.g., by the second wireless node). In such cases, the first wireless node may output a request for the one or more second frames to the second wireless node. The one or more second frames are then obtained by the first wireless node (e.g., from the second wireless node), in accordance with the outputted request.

In certain aspects, a third field of the first frame may contain one or more of the second set of parameters.

In certain aspects, a fourth field of the first frame may indicate an update of information associated with one or more of the second set of parameters.

In one aspect, method 1200, or any aspect related to it, may be performed by an apparatus, such as a wireless communications device 1300 of FIG. 13, which includes various components operable, configured, or adapted to perform the method 1200. The wireless communications device 1300 is described below in further detail.

Note that FIG. 12 is just one example of a method, and other methods including fewer, additional, or alternative steps are possible consistent with this disclosure.

FIG. 13 shows a block diagram of a wireless communication device or node 1300 (e.g., an AP, a STA (such as a non-AP STA), a non-AP MLD), according to some aspects of the present disclosure. In one example, the wireless communication device 1300 is configured or operable to perform a process 900 described with reference to FIG. 9. In another example, the wireless communication device 1300 is configured or operable to perform a process 1000 described with reference to FIG. 10. In another example, the wireless communication device 1300 is configured or operable to perform a process 1100 described with reference to FIG. 11. In another example, the wireless communication device 1300 is configured or operable to perform a process 1200 described with reference to FIG. 12.

The wireless communication device 1300 may include one or more chips, SoCs, chipsets, packages, components or devices that individually or collectively constitute or comprise a processing system. The processing system may interface with other components of the wireless communication device 1300, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the device 1300 may transmit the information output from the chip. In such an example, the second interface may refer to an interface between the processing system of the chip and a reception component, such that the device 1300 may receive information that is then passed to the processing system. In some such examples, the first interface also may obtain information, such as from the transmission component, and the second interface also may output information, such as to the reception component.

The processing system of the wireless communication device 1300 includes processor (or “processing”) circuitry in the form of one or multiple processors, microprocessors, processing units (such as central processing units (CPUs), graphics processing units (GPUs) or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1300 can be a device for use in an AP or an AP MLD, such as AP 102 described with reference to FIG. 1. In some other examples, the wireless communication device 1300 can be an AP that includes such a processing system and other components including multiple antennas. The wireless communication device 1300 is capable of transmitting and receiving wireless communications in the form of, for example, wireless packets. For example, the wireless communication device 1300 can be configurable or configured to transmit and receive packets in the form of physical layer PPDUs and MPDUs conforming to one or more of the IEEE 802.11bn (or higher) family of wireless communication protocol standards. In some other examples, the wireless communication device 1300 can be configurable or configured to transmit and receive signals and communications conforming to one or more 3GPP specifications including those for 5G NR or 6G. In some examples, the wireless communication device 1300 also includes or can be coupled with one or more application processors which may be further coupled with one or more other memories. In some examples, the wireless communication device 1300 further includes at least one external network interface coupled with the processing system that enables communication with a core network or backhaul network that enables the wireless communication device 1300 to gain access to external networks including the Internet.

In some examples, the wireless communication device 1300 can be a device for use in a STA/a non-AP STA, such as STA 104 described with reference to FIG. 1. In some examples, the wireless communication device 1300 further includes a user interface (UI) (such as a touchscreen or keypad) and a display, which may be integrated with the UI to form a touchscreen display. In some examples, the wireless communication device 1300 may further include one or more sensors such as, for example, one or more inertial sensors, accelerometers, temperature sensors, pressure sensors, or altitude sensors.

The wireless communication device 1300 includes obtaining component 1302, outputting component 1304, and/or processing component 1306. Portions of the obtaining component 1302, the outputting component 1304, and/or the processing component 1306 may be implemented at least in part in hardware or firmware. For example, the obtaining component 1302, the outputting component 1304, and/or the processing component 1306 may be implemented at least in part by a modem. In some examples, at least some of the components such as the obtaining component 1302, the outputting component 1304, and/or the processing component 1306 are implemented at least in part by one or more processors and as software stored in a memory. For example, portions of the obtaining component 1302, the outputting component 1304, and/or the processing component 1306 can be implemented as non-transitory instructions (or “code”) executable by the processor to perform the functions or operations of the respective module.

The obtaining component 1302 may be capable of, is configurable or configured to, or operable to at least obtain one or more first frames and one or more second frames.

The outputting component 1304 may be capable of, is configurable or configured to, or operable to at least output (e.g., for transmission) one or more first frames and one or more second frames.

The processing component 1306 may be capable of, is configurable or configured to, or operable to at least process one or more first frames and one or more second frames.

Various components of the wireless communication device 1300 may provide means for performing the process 900 described with reference to FIG. 9, the process 1000 described with reference to FIG. 10, the process 1100 described with reference to FIG. 11, the process 1200 described with reference to FIG. 12, or any aspect related to it. Means for receiving or obtaining may include transceivers and/or antenna(s) of the AP 102 (or the STA 104) described with reference to FIG. 1 and/or the obtaining component 1302 of the wireless communication device 1300. Means for transmitting, sending or outputting (e.g., for transmission) may include transceivers and/or antenna(s) of the AP 102 (or the STA 104) described with reference to FIG. 1 and/or the outputting component 1304 of the wireless communication device 1300. Means for processing may include processors, transceivers and/or antenna(s) of the AP 102 (or the STA 104) described with reference to FIG. 1 and/or the processing component 1306 of the wireless communication device 1300.

In some cases, rather than actually transmitting, for example, signals and/or data, the wireless communication device 1300 may have an interface to output signals and/or data for transmission (means for outputting). For example, a processor may output signals and/or data, via a bus interface, to a radio frequency (RF) front end of the wireless communication device 1300 for transmission. In various aspects, the RF front end may include various components, including transmit and receive processors, transmit and receive MIMO processors, modulators, demodulators, and the like.

In some cases, rather than actually receiving signals and/or data, the wireless communication device 1300 may have an interface to obtain the signals and/or data received from another device (means for obtaining). For example, a processor may obtain (or receive) the signals and/or data, via a bus interface, from an RF front end of the wireless communication device 1300 for reception. In various aspects, the RF front end may include various components, including transmit and receive processors, transmit and receive MIMO processors, modulators, demodulators, and the like.

### Example Clauses

Implementation examples are described in the following numbered clauses.

Clause 1: A method for wireless communication performable at a first wireless node, comprising: outputting a first frame comprising one or more first fields, wherein at least one of the one or more first fields indicates at least one of: a presence of one or more second frames, a presence of at least one of one or more second fields or second elements in at least one of the one or more second frames, or one or more attributes corresponding to the at least one of the one or more second frames; and outputting the one or more second frames.

Clause 2: The method of Clause 1, wherein the first frame is a first beacon frame.

Clause 3: The method of any one of Clauses 1-2, wherein the at least one of the one or more second frames is at least one of: a second beacon frame, a new frame, a beacon extension frame, a follow-up beacon frame, or a link recommendation frame.

Clause 4: The method of any one of Clauses 1-3, wherein the one or more second frames are outputted within a first time period from outputting of the first frame.

Clause 5: The method of any one of Clauses 1-4, wherein the one or more second frames are outputted after a first time period from outputting of the first frame.

Clause 6: The method of any one of Clauses 1-5, wherein: the first frame is outputted for transmission using a first set of one or more transmission parameters comprising at least one of a first transmission periodicity, a first transmission data rate, a first bandwidth, or a first frame format; and the one or more second frames are outputted for transmission using a second set of one or more transmission parameters comprising at least one of a second transmission periodicity, a second transmission data rate, a second bandwidth, or a second frame format.

Clause 7: The method of Clause 6, wherein a value of the first transmission periodicity is same as a value of the second transmission periodicity.

Clause 8: The method of Clause 6, wherein a value of the first transmission periodicity is different from a value of the second transmission periodicity.

Clause 9: The method of Clause 6, wherein a value of the first transmission data rate is same as a value of the second transmission data rate.

Clause 10: The method of Clause 6, wherein a value of the first transmission data rate is different from a value of the second transmission data rate.

Clause 11: The method of Clause 6, wherein a value of the first bandwidth is same as a value of the second bandwidth.

Clause 12: The method of Clause 6, wherein a value of the first bandwidth is different from a value of the second bandwidth.

Clause 13: The method of Clause 6, wherein the first frame format is same as the second frame format.

Clause 14: The method of Clause 6, wherein the first frame format is different from the second frame format.

Clause 15: The method of any one of Clauses 1-14, wherein the at least one of the one or more first fields further indicates an absence of one or more third fields in the at least one of the one or more second frames.

Clause 16: The method of Clause 15, wherein at least one of: the presence of the one or more second fields or second elements in the at least one of the one or more second frames or the absence of the one or more third fields in the at least one of the one or more second frames indicates a type of data carried by the at least one of the one or more second frames.

Clause 17: The method of any one of Clauses 1-16, wherein an order of the one or more second fields or second elements in the second frame indicates a type of data carried by the at least one of the one or more second frames.

Clause 18: The method of any one of Clauses 1-17, wherein one or more values within the one or more second fields or second elements in the at least one of the one or more second frames indicates a type of data carried by the at least one of the one or more second frames.

Clause 19: The method of any one of Clauses 1-18, wherein the first wireless node is an access point (AP).

Clause 20: The method of any one of Clauses 1-19, further comprising outputting the first frame for transmission to one or more second wireless nodes, and wherein one of the one or more second wireless nodes is a non-access point (AP) wireless station (STA) or a non-AP multi-link device (MLD).

Clause 21: The method of any one of Clauses 1-20, wherein one of the one or more attributes is a periodicity of the at least one of the one or more second frames.

Clause 22: The method of any one of Clauses 1-21, wherein the at least one of the one or more first fields further indicates a type of data or information carried by the at least one of the one or more second frames.

Clause 23: The method of any one of Clauses 1-22, wherein the first frame is outputted to a broadcast address.

Clause 24: The method of any one of Clauses 1-23, wherein: the first frame is associated with at least one of: a first packet number or a first sequence number; and the at least one of the one or more second frames is associated with the at least one of: the first packet number or the first sequence number.

Clause 25: The method of any one of Clauses 1-24, wherein: at least one field or element carried in the first frame is associated with a first set of one or more attributes comprising at least one of a first format, a first type of encoding, a first interpretation or a first granularity level; the at least one same field or element carried in the second frame is associated with a second set of one or more attributes comprising at least one of a second format, a second type of encoding, a second interpretation or a second granularity level; and the first set of one or more attributes is different from the second set of one or more attributes.

Clause 26: A method for wireless communication performable at a first wireless node, comprising: obtaining a first frame comprising one or more first fields, wherein at least one of the one or more first fields indicates at least one of: a presence of one or more second frames, a presence of at least one of one or more second fields or second elements in at least one of the one or more second frames, or one or more attributes corresponding to the at least one of the one or more second frames; and obtaining the one or more second frames.

Clause 27: The method of Clause 26, wherein the first frame is a first beacon frame.

Clause 28: The method of any one of Clauses 26-27, wherein the at least one of the one or more second frames is at least one of: a second beacon frame, a new frame, a beacon extension frame, a follow-up beacon frame, or a link recommendation frame.

Clause 29: The method of any one of Clauses 26-28, wherein the at least one of the one or more first fields further indicates an absence of one or more third fields in the at least one of the one or more second frames.

Clause 30: The method of any one of Clauses 26-29, wherein an order of the one or more second fields or second elements in the second frame indicates a type of data carried by the at least one of the one or more second frames.

Clause 31: A method for wireless communication performable at a wireless node, comprising: outputting a first frame comprising a plurality of fields, wherein a first field of the first frame indicates transmission information associated with one or more second frames and a second field of the first frame contains a first set of parameters associated with the wireless node; and outputting the one or more second frames, wherein one of the one or more second frames comprises at least one field containing a second set of parameters associated with the wireless node, and wherein the first set of parameters are different from the second set of parameters.

Clause 32: The method of Clause 31, wherein the transmission information associated with the one or more second frames indicates a presence of the one or more second frames or an absence of the one or more second frames.

Clause 33: The method of Clause 32, wherein the presence of the one or more second frames indicates: no request for the one or more second frames is required by the wireless node to output the one or more second frames; and at least one of: a transmission time associated with the one or more second frames or a transmission periodicity associated with the one or more second frames.

Clause 34: The method of Clause 32, wherein the absence of the one or more second frames indicates a request for the one or more second frames is required by the wireless node to output the one or more second frames.

Clause 35: The method of any one of Clauses 31-34, further comprising obtaining a request for the one or more second frames, and wherein the one or more second frames are outputted after obtaining the request.

Clause 36: The method of any one of Clauses 31-35, wherein: the first frame is a first beacon frame; and each of the one or more second frames is a second beacon frame, a new frame, a beacon extension frame, a follow-up beacon frame, a probe response frame, a broadcast frame, an association response frame, a reassociation response frame, a link reconfiguration frame, or a link recommendation frame.

Clause 37: The method of any one of Clauses 31-36, wherein the one or more second frames are outputted within a first time period from outputting of the first frame.

Clause 38: The method of any one of Clauses 31-37, wherein the one or more second frames are outputted after a first time period from outputting of the first frame.

Clause 39: The method of any one of Clauses 31-38, wherein the first frame is outputted by using a first set of one or more transmission parameters comprising at least one of a first transmission periodicity, a first transmission data rate, a first bandwidth, or a first frame format; and the one or more second frames are outputted by using a second set of one or more transmission parameters comprising at least one of a second transmission periodicity, a second transmission data rate, a second bandwidth, or a second frame format.

Clause 40: The method of Clause 39, wherein at least one of: a value of the first transmission periodicity is same as a value of the second transmission periodicity; a value of the first transmission data rate is same as a value of the second transmission data rate; a value of the first bandwidth is same as a value of the second bandwidth; or the first frame format is same as the second frame format.

Clause 41: The method of Clause 39, wherein at least one of: a value of the first transmission periodicity is different from a value of the second transmission periodicity; a value of the first transmission data rate is different from a value of the second transmission data rate; a value of the first bandwidth is different from a value of the second bandwidth; or the first frame format is different from the second frame format.

Clause 42: The method of any one of Clauses 31-41, wherein the one of the one or more second frames comprises a plurality of fields, and wherein an order of the plurality of fields in the particular one of the one or more second frames indicates a type of data carried by the particular one of the one or more second frames.

Clause 43: The method of any one of Clauses 31-42, wherein one or more values within the at least one field indicate a type of data carried by the one or more second frames.

Clause 44: The method of any one of Clauses 31-43, wherein a third field of the first frame indicates a type of data or information carried by the one or more second frames.

Clause 45: The method of any one of Clauses 31-44, wherein at least one of: the first frame or the one or more second frames are outputted for transmission based on a broadcast address.

Clause 46: The method of any one of Clauses 31-45, wherein: the first frame is associated with at least one of: a first packet number or a first sequence number; and each of the one or more second frames is associated with the at least one of: the first packet number or the first sequence number.

Clause 47: The method of any one of Clauses 31-46, wherein: at least one of the plurality of fields in the first frame is associated with a first set of one or more attributes comprising at least one of a first format, a first type of encoding, a first interpretation or a first granularity level; the at least one field in the one of the one or more second frames is associated with a second set of one or more attributes comprising at least one of a second format, a second type of encoding, a second interpretation or a second granularity level; and the first set of one or more attributes is different from the second set of one or more attributes.

Clause 48: The method of any one of Clauses 31-47, wherein a third field of the first frame includes one or more of the second set of parameters, and wherein the inclusion is based on an update of information associated with the one or more of the second set of parameters.

Clause 49: The method of any one of Clauses 31-48, wherein a third field of the first frame indicates an update of information associated with one or more of the second set of parameters.

Clause 50: The method of any one of Clauses 31-49, wherein the wireless node is an access point (AP).

Clause 51: A method for wireless communication performable at a first wireless node, comprising: obtaining a first frame comprising a plurality of fields, wherein a first field of the first frame indicates transmission information associated with one or more second frames and a second field of the first frame contains a first set of parameters associated with a second wireless node; obtaining the one or more second frames, wherein one of the one or more second frames comprises at least one field containing a second set of parameters associated with the second wireless node, and wherein the first set of parameters are different from the second set of parameters; and processing the first frame and the one or more second frames.

Clause 52: The method of Clause 51, wherein the transmission information associated with the one or more second frames indicates a presence of the one or more second frames or an absence of the one or more second frames.

Clause 53: The method of Clause 52, wherein the presence of the one or more second frames indicates: no request for the one or more second frames is required from the first wireless node; and at least one of: a transmission time or a transmission periodicity associated with the one or more second frames.

Clause 54: The method of Clause 52, wherein the absence of the one or more second frames indicates a request for the one or more second frames is required from the first wireless node.

Clause 55: The method of any one of Clauses 51-54, further comprising outputting a request for the one or more second frames, and wherein the one or more second frames are obtained after outputting the request.

Clause 56: The method of any one of Clauses 51-55, wherein a third field of the first frame contains one or more of the second set of parameters.

Clause 57: The method of any one of Clauses 51-56, wherein a third field of the first frame indicates an update of information associated with one or more of the second set of parameters.

Clause 58: The method of any one of Clauses 51-57, wherein the first wireless node is wireless station (STA).

Clause 59: An apparatus, comprising: at least one memory comprising executable instructions; and one or more processors, individually or collectively, configured to execute the executable instructions and cause the apparatus to perform a method in accordance with any one of Clauses 1-58.

Clause 60: An apparatus, comprising means for performing a method in accordance with any one of Clauses 1-58.

Clause 61: A non-transitory computer-readable medium comprising executable instructions that, when executed by one or more processors of an apparatus, cause the apparatus to perform a method in accordance with any one of Clauses 1-58.

Clause 62: A computer program product embodied on a computer-readable storage medium comprising code for performing a method in accordance with any one of Clauses 1-58.

Clause 63: An access point (AP), comprising: at least one transceiver; a memory comprising executable instructions; and one or more processors, individually or collectively, configured to execute the executable instructions and cause the AP to perform a method in accordance with any one of Clauses 1-25, wherein the at least one transceiver is configured to transmit the first frame and the one or more second frames.

Clause 64: A non-access point (AP) wireless station (STA), comprising: at least one transceiver; a memory comprising executable instructions; and one or more processors, individually or collectively, configured to execute the executable instructions and cause the non-AP STA to perform a method in accordance with any one of Clauses 26-30, wherein the at least one transceiver is configured to receive the first frame and the one or more second frames.

Clause 65: A non-access point (AP) multi-link device (MLD), comprising: at least one transceiver; a memory comprising executable instructions; and one or more processors, individually or collectively, configured to execute the executable instructions and cause the non-AP MLD to perform a method in accordance with any one of Clauses 26-30, wherein the at least one transceiver is configured to receive the first frame and the one or more second frames.

Clause 66: An access point (AP), comprising: at least one transceiver; a memory comprising executable instructions; and one or more processors, individually or collectively, configured to execute the executable instructions and cause the AP to perform a method in accordance with any one of Clauses 31-50, wherein the at least one transceiver is configured to transmit the first frame and the one or more second frames.

Clause 67: A wireless station (STA), comprising: at least one transceiver; a memory comprising executable instructions; and one or more processors, individually or collectively, configured to execute the executable instructions and cause the STA to perform a method in accordance with any one of Clauses 51-58, wherein the at least one transceiver is configured to receive the first frame and the one or more second frames.

Clause 68: A non-access point (AP) multi-link device (MLD), comprising: at least one transceiver; a memory comprising executable instructions; and one or more processors, individually or collectively, configured to execute the executable instructions and cause the non-AP MLD to perform a method in accordance with any one of Clauses 51-58, wherein the at least one transceiver is configured to receive the first frame and the one or more second frames.

### Additional Considerations

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b.

As used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information.

The various illustrative components, logic, logical blocks, modules, circuits, operations and algorithm processes described in connection with the examples disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable sub combination. As such, although features may be described above as acting in particular combinations, and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

As used herein, the term wireless node may refer to, for example, an access point (AP) station (STA) or a non-AP STA. An AP STA generally refers to a STA that is (or is capable of) serving/functioning as an AP (which may be referred to simply as an AP) or capable of serving/functioning as an AP. A non-AP STA generally refers to a STA that is not serving/functioning as an AP (which may be referred to simply as an STA).

While the present disclosure may describe certain operations as being performed by one type of wireless node, the same or similar operations may also be performed by another type of wireless node. For example, operations performed by an AP STA may also (or instead) be performed by a non-AP STA. Similarly, operations performed by a non-AP STA may also (or instead) be performed by an AP STA.

Further, while the present disclosure may describe certain types of communications between different types of wireless nodes (e.g., between an AP STA and a non-AP STA), the same or similar types of communications may occur between same types of wireless nodes (e.g., between AP STAs or between non-AP STAs, in a peer-to-peer scenario). Further, communications may occur in reverse order than described.

1. An apparatus for wireless communication, comprising:
at least one memory comprising instructions; and
one or more processors, individually or collectively, configured to execute the instructions and cause the apparatus to:
output a first frame comprising a plurality of fields, wherein a first field of the first frame indicates transmission information associated with one or more second frames and a second field of the first frame contains a first set of parameters associated with the apparatus; and
output the one or more second frames, wherein one of the one or more second frames comprises at least one field containing a second set of parameters associated with the apparatus, and wherein the first set of parameters are different from the second set of parameters.

2. The apparatus of claim 1, wherein the transmission information associated with the one or more second frames indicates a presence of the one or more second frames or an absence of the one or more second frames.

3. The apparatus of claim 2, wherein the presence of the one or more second frames indicates:
no request for the one or more second frames is required by the apparatus to output the one or more second frames; and
at least one of: a transmission time associated with the one or more second frames or a transmission periodicity associated with the one or more second frames.

4. The apparatus of claim 2, wherein the absence of the one or more second frames indicates a request for the one or more second frames is required by the apparatus to output the one or more second frames.

5. The apparatus of claim 1, wherein the one or more processors, individually or collectively, are further configured to execute the instructions and cause the apparatus to obtain a request for the one or more second frames, and wherein the one or more second frames are outputted after obtaining the request.

6. The apparatus of claim 1, wherein:
the first frame is a first beacon frame; and
each of the one or more second frames is a second beacon frame, a new frame, a beacon extension frame, a follow-up beacon frame, a probe response frame, a broadcast frame, an association response frame, a reassociation response frame, a link reconfiguration frame, or a link recommendation frame.

7. The apparatus of claim 1, wherein the one or more second frames are outputted within a first time period from outputting of the first frame.

8. The apparatus of claim 1, wherein the one or more second frames are outputted after a first time period from outputting of the first frame.

9. The apparatus of claim 1, wherein:
the first frame is outputted by using a first set of one or more transmission parameters comprising at least one of a first transmission periodicity, a first transmission data rate, a first bandwidth, or a first frame format; and
the one or more second frames are outputted by using a second set of one or more transmission parameters comprising at least one of a second transmission periodicity, a second transmission data rate, a second bandwidth, or a second frame format.

10. The apparatus of claim 9, wherein at least one of:
a value of the first transmission periodicity is same as a value of the second transmission periodicity;
a value of the first transmission data rate is same as a value of the second transmission data rate;
a value of the first bandwidth is same as a value of the second bandwidth; or
the first frame format is same as the second frame format.

11. The apparatus of claim 9, wherein at least one of:
a value of the first transmission periodicity is different from a value of the second transmission periodicity;
a value of the first transmission data rate is different from a value of the second transmission data rate;
a value of the first bandwidth is different from a value of the second bandwidth; or
the first frame format is different from the second frame format.

12. The apparatus of claim 1, wherein the one of the one or more second frames comprises a plurality of fields, and wherein an order of the plurality of fields in the particular one of the one or more second frames indicates a type of data carried by the particular one of the one or more second frames.

13. The apparatus of claim 1, wherein one or more values within the at least one field indicate a type of data carried by the one or more second frames.

14. The apparatus of claim 1, wherein a third field of the first frame indicates a type of data or information carried by the one or more second frames.

15. The apparatus of claim 1, wherein at least one of: the first frame or the one or more second frames are outputted for transmission based on a broadcast address.

16. The apparatus of claim 1, wherein:
the first frame is associated with at least one of: a first packet number or a first sequence number; and
each of the one or more second frames is associated with the at least one of: the first packet number or the first sequence number.

17. The apparatus of claim 1, wherein:
at least one of the plurality of fields in the first frame is associated with a first set of one or more attributes comprising at least one of a first format, a first type of encoding, a first interpretation or a first granularity level;
the at least one field in the one of the one or more second frames is associated with a second set of one or more attributes comprising at least one of a second format, a second type of encoding, a second interpretation or a second granularity level; and
the first set of one or more attributes is different from the second set of one or more attributes.

18. The apparatus of claim 1, wherein a third field of the first frame includes one or more of the second set of parameters, and wherein the inclusion is based on an update of information associated with the one or more of the second set of parameters.

19. The apparatus of claim 1, wherein a third field of the first frame indicates an update of information associated with one or more of the second set of parameters.

20. The apparatus of claim 1, further comprising at least one transceiver configured to transmit the first frame and the one or more second frames, wherein the apparatus is configured as an access point (AP).

21. A first apparatus for wireless communication, comprising:
at least one memory comprising instructions; and
one or more processors, individually or collectively, configured to execute the instructions and cause the apparatus to:
obtain a first frame comprising a plurality of fields, wherein a first field of the first frame indicates transmission information associated with one or more second frames and a second field of the first frame contains a first set of parameters associated with a second apparatus;
obtain the one or more second frames, wherein one of the one or more second frames comprises at least one field containing a second set of parameters associated with the second apparatus, and wherein the first set of parameters are different from the second set of parameters; and
process the first frame and the one or more second frames.

22. The first apparatus of claim 21, wherein the transmission information associated with the one or more second frames indicates a presence of the one or more second frames or an absence of the one or more second frames.

23. The first apparatus of claim 22, wherein the presence of the one or more second frames indicates:
no request for the one or more second frames is required from the first apparatus; and
at least one of: a transmission time or a transmission periodicity associated with the one or more second frames.

24. The first apparatus of claim 22, wherein the absence of the one or more second frames indicates a request for the one or more second frames is required from the first apparatus.

25. The first apparatus of claim 21, wherein the one or more processors, individually or collectively, are further configured to execute the instructions and cause the first apparatus to output a request for the one or more second frames, and wherein the one or more second frames are obtained after outputting the request.

26. The first apparatus of claim 21, wherein a third field of the first frame contains one or more of the second set of parameters.

27. The first apparatus of claim 21, wherein a third field of the first frame indicates an update of information associated with one or more of the second set of parameters.

28. The first apparatus of claim 21, further comprising at least one transceiver configured to receive the first frame and the one or more second frames, wherein the first apparatus is configured as a wireless station (STA).

29. A method for wireless communication performable at a first wireless node comprising:
outputting a first frame comprising a plurality of fields, wherein a first field of the first frame indicates transmission information associated with one or more second frames and a second field of the first frame contains a first set of parameters associated with the first wireless node; and
outputting the one or more second frames, wherein one of the one or more second frames comprises at least one field containing a second set of parameters associated with the first wireless node, and wherein the first set of parameters are different from the second set of parameters.
